(19) United States
(12) Patent Application Publication
(10) Pub. No.: US 2010/0011894 A1
(43) Pub. Date: Jan. 21, 2010

(54) VEHICLE DRIVE DEVICE AND A VEHICLE COMPRISING THE SAME

(75) Inventors: Chuanfu WANG, Shenzhen (CN); Hongbin Luo, Shenzhen (CN); Ruzhong Luo, Shenzhen (CN); Yi Ren, Shenzhen (CN); Guangquan Chen, Shenzhen (CN); Kaizhao Li, Shenzhen (CN); Yu Yan, Shenzhen (CN)

Correspondence Address: BRINKS HOFER GILSON & LIONE, P.O. BOX 10395, CHICAGO, IL, 60610, US

(73) Assignee: BYD Company Limited, Shenzhen (CN)

(21) Appl. No.: 12/505,063

(22) Filed: Jul. 17, 2009

(30) Foreign Application Priority Data
Jul. 18, 2008 (CN) 2008-10116883.7

(51) Int. Cl. F16H 57/00; F16H 1/02; F16H 37/12

(52) U.S. Cl. 74/411.5

(57) ABSTRACT

A vehicle drive device includes a main shaft operatively coupled to a motor of the vehicle, where the main shaft has a drive gear, and a countershaft having a drive gear and a driven gear. The drive gear of the main shaft is configured to engage the driven gear of the countershaft. Also included is a differential having a driven gear and a half axle gear, where the drive gear of the countershaft is configured to engage the driven gear of the differential, and the half axle gear of the differential is configured to drive a wheel of the vehicle. A parking mechanism is connected with the countershaft and is configured to lock the countershaft in a parking mode.

### CROSS-REFERENCE TO RELATED APPLICATIONS

This application claims the benefit of priority to Chinese Patent Application No. 2008-10116883.7 filed on Jul. 18, 2008, which is incorporated by reference herein in its entirety.

### FIELD OF TECHNOLOGY

This application relates to a vehicle drive device, especially to a vehicle drive device with a parking mechanism. This application also relates to a vehicle with the drive device.

### BACKGROUND OF THE INVENTION

With the increasingly exhausted oil resource and the continuous increase of the oil price, people pay more attention to the vehicle with the new drive resource. So, it becomes one of the important questions that how to utilize electricity power to drive the vehicles efficiently in the automobile industry. Now, most of the vehicle drive devices are of the common fuel engine drive device. The power generated by the engine is not constant, so its drive device is designed to multi-drive device. The power resource of the vehicle using electricity power is constant provided by the battery, so the transmission of the common fuel engine doesn't fit the vehicle using the electricity power. In addition, the operation mode of the internal combustion engine is very complicated, common people cannot be familiar to it, and the maintenance is also complicated.

The application CN1559821A disclosed a motor drive device of a light electric vehicle, its transmission system comprises a pinion, a middle gear, large gear and an overrunning clutch. The pinion is connected to the output shaft of the motor; the pinion is link-operated with the big gear by the middle gear; the big gear is connected to the driving shaft of the electric vehicle by the overrunning clutch. This kind of the drive device can drive the electric vehicle using the electricity power, but it only can drive the electric vehicle with two wheels, like electric bicycles, electric motorcycles, etc.

### SUMMARY

A vehicle drive device includes a main shaft operatively coupled to a motor of the vehicle, where the main shaft has a drive gear, and a countershaft having a drive gear and a driven gear. The drive gear of the main shaft is configured to engage the driven gear of the countershaft. Also included is a differential having a driven gear and a half axle gear, where the drive gear of the countershaft is configured to engage the driven gear of the differential, and the half axle gear of the differential is configured to drive a wheel of the vehicle. A parking mechanism is connected with the countershaft and is configured to lock the countershaft in a parking mode.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is the scheme of the power transmission line of the vehicle drive device of one embodiment.

FIG. 2 is the structure layout scheme of the main shaft and countershaft of the vehicle drive device of one embodiment.

FIG. 3 is the scheme of the transmission and parking mechanism of the vehicle drive device of one embodiment.

FIG. 4 is the differential structure scheme of one embodiment.

FIG. 5 is main shaft component scheme of one embodiment.

FIG. 6 is the countershaft component scheme of one embodiment.

FIG. 7 is the structure scheme of the ratchet wheel and the ratchet hand of one embodiment.

FIG. 8 is the push rod component scheme of one embodiment.

FIG. 9 shows the orientation of the position block board.

### DETAILED DESCRIPTION OF THE PREFERRED EMBODIMENT

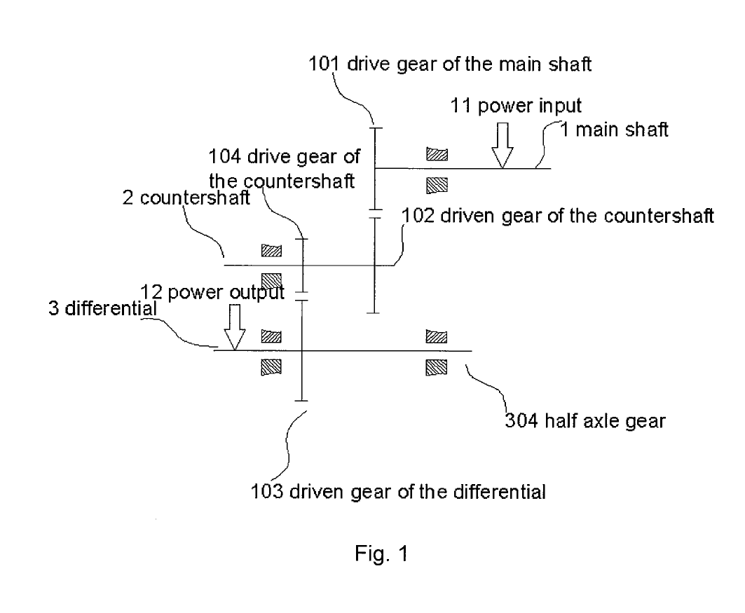

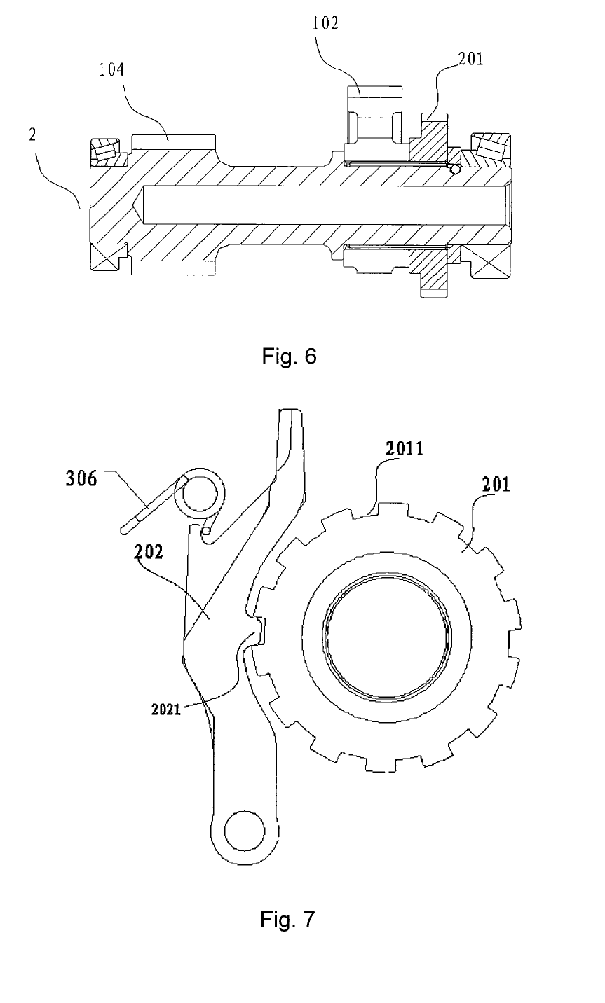

According to FIG. 1-6, a vehicle drive device includes a main shaft I operatively coupled to a motor of the vehicle, where the main shaft 1 has a drive gear 101, and a countershaft 2 having a drive gear 104 and a driven gear 102. The drive gear 101 of the main shaft is configured to engage the driven gear 102 of the countershaft. Also included is a differential 3 having a driven gear 301 and a half axle gear 304, where the drive gear 104 of the countershaft 2 is configured to engage the driven gear 301 of the differential 3, and the half axle gear 304 of the differential 3 is configured to drive a wheel of the vehicle. A parking mechanism is connected with the countershaft 2 and is configured to lock the countershaft 2 in a parking mode

The main shaft 1 is connected to the drive motor to function as the power input shaft. The connection method may be any method known to those skilled in the art, such as a spline connection. The spline connection may have the constant transmission ratio. In addition, in one embodiment, the main shaft 1 and the drive gear 101 of the main shaft may be single-body pinion shaft. The countershaft 2, the driven gear 102 and the drive gear 104 of the countershaft may be single-body pinion shaft. This can improve the efficiency of the power transmission to get a constant transmission ratio. The vehicle may be any vehicle that can use electrical power as at least part of its resource, such as an electric vehicle or a hybrid vehicle.

The drive gear 101 is configured to engage the driven gear 102 of the countershaft 2. When the drive motor drives the main shaft 1, the main shaft 1 drives the countershaft 2 to rotate by the engagement of the drive gear 101 with the driven gear 102. Because the driven gear 301 of the differential engages the drive gear 104 of the countershaft, the countershaft 2 rotates to drive the differential 3 to operate. The half axle shaft 304 of the differential is connected to the vehicle wheel, so the differential 3 drives the vehicle wheel to rotate by the rotation of the half axle shaft 304 of the differential. Because the structure of the vehicle drive device in the embodiment is simple, only the connection and the engagement of the main shaft 1 and the countershaft 2, which is the simple one-level shifting drive, it is easy to use and can save much cost of the production, using and repair, meanwhile, it meets the parking demand. The vehicle drive device can utilize the power provided by the drive motor to meet the power demand of the electric vehicle and shifting.

According to FIG. 1, the arrows show the power transmission direction. Arrow 11 shows the power input, and arrow 12 shows the power output. The engine transfers the power to the main shaft 1 through the countershaft 2, the differential 3, and outputs the power.

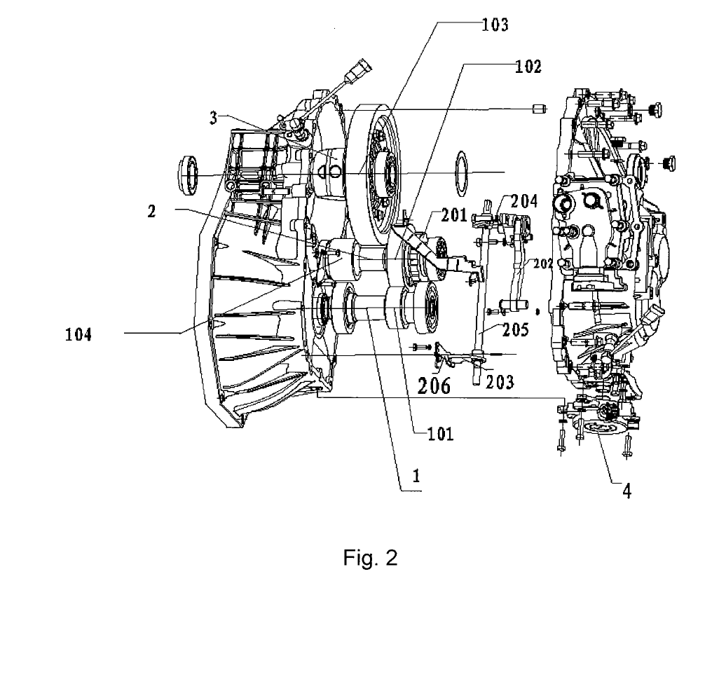

According to FIGS. 2-3 and FIGS. 7-8, in one embodiment, a parking mechanism further comprises a ratchet wheel 201 located on the countershaft 2, a ratchet hand 202 installed on a body portion of the vehicle, a parking transmission shaft 205 having a first end and a second end, a parking motor 4 connected to the first end of the parking transmission shaft 205 and configured to selectively rotate the parking transmission shaft 205, a positioning block board 203 coupled to the second end of the parking transmission shaft 205 and configured to retain the parking transmission shaft 205 in a fixed orientation and permit the parking transmission shaft 205 to rotate, a push rod 204 configured to reciprocally engage the ratchet hand 202, and a positioning board spring 206 coupled to the positioning block board 203. The other end of the positioning block board 203 is connected to one end of the positioning board spring 206. The other end of the positioning board spring 206 is fixed on the transmission body.

According to FIG. 9 the positioning block board 203 is in position 1. When parking, the positioning block board 203 rotates with the rotation of the motor to position 2 to perform a parking operation, the rotation of the parking transmission shaft 205 drives the push rod 204 to reciprocally engage and disengage the ratchet hand with the ratchet wheel 201.

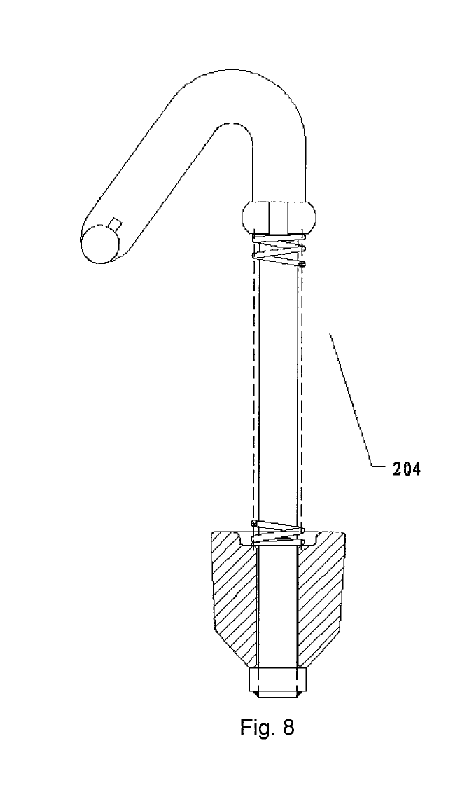

According to FIG. 7, a stopping tooth 2021 of the ratchet hand 202 may be configured to selectively engage a corresponding recess 2011 in the ratchet wheel 201. Those skilled in the art may use any known method to realize the engagement. In one embodiment, the stopping tooth 2021 of the ratchet hand 202 and the recess 2011 of the ratchet wheel 201 are rectangular or arc in shape, which may enhance the engagement of the ratchet hand 202 with the ratchet wheel 201. When the ratchet hand 202 is disengaged to the ratchet wheel 201, there is a certain clearance between the stopping gear 2021 of the ratchet hand 202 and the recess 2011 of the ratchet wheel 201. Accordingly, the countershaft 2 can rotate freely without the effect of the ratchet hand 202.

In another embodiment, the ratchet hand 202 may have a return spring 306 configured to bias the ratchet hand 202 away from the ratchet wheel 201, which ensures that there is a certain clearance between the ratchet hand 202 and the ratchet wheel 201 when not start the parking mechanism, and ensures the driving safety. In addition, the second end of the parking transmission shaft 205 is fixed by one end of the positioning block board 203 to ensure the safety of the parking mechanism.

By driving the parking motor 4, the parking transmission shaft 205 rotates to drive the push rod 204 to reciprocally engage or disengage the ratchet hand 202 with the ratchet wheel 201, then realize the vehicle parking and un-parking separately.

While parking required, the parking motor 4 drives the parking transmission shaft 205 to rotate. Because the push rod 204 is connected with the parking transmission shaft 205, the rotation of the parking transmission shaft 205 may drive the push rod 204 to rotate, furthermore, the push rod 204 drives the ratchet hand 202 to engage to the ratchet wheel 201. Because the ratchet wheel 201 is connected to the countershaft 2, the engagement of the ratchet hand 202 and the ratchet wheel 201 may stop the rotation of the countershaft 2, namely, the countershaft is locked. The driven gear 102 of the countershaft is always engaged to the driven gear 301 of the differential, so the lock of the countershaft 2 stops the rotation of the differential, and then the wheel is locked, which is the goal of the parking mechanism.

Whereas, while the parking not required, the parking motor 4 drives the parking transmission shaft 205 to rotate. Because the push rod 204 is connected with the parking transmission shaft 205, the rotation of the parking transmission shaft 205 may drive the push rod 204 to rotate, furthermore, the push rod 204 drives the ratchet hand 202 to disengage to the ratchet wheel 201. Because the ratchet wheel 201 is connected to the countershaft 2, the disengagement of the ratchet hand 202 and the ratchet wheel 201 may drive the countershaft 2 to rotate. The driven gear 102 of the countershaft is always engaged to the driven gear 301 of the differential, so the rotation of the countershaft 2 drives the differential to operate, and then the wheel is droved to rotate.

Because the motor provides the electricity power to the vehicle, and the motor operates by the support of the battery, the drive mode of the motor is different from the drive mode of the internal combustion engine, the ability of the rotation speed is also different. Generally, the internal combustion engine has the return compression counterforce, so the parking mechanism with the internal combustion engine can obtain the assistant impetus and the auxiliary force easily. The motor has no return compression counterforce, then the driver using electricity power has no self-locking assistant impetus and it may rotate easily without the electricity driving. The main shaft 1 is always engaged to the countershaft 2, and the countershaft 2 is always engaged to the differential 3, so the wheel rotates to drive the main shaft 1 and the countershaft 2 to rotate, the main shaft 1 rotates to drive the vehicle motor to rotate, then the vehicle may lose the safe parking efficiency by the spontaneous power driving. The parking mechanism in the embodiment ensures the safe parking of the vehicle even on the slope.

In one embodiment, the parking motor is controlled by the control system of the parking mechanism. The decision of starting the parking mechanism or not is made according to the specific condition. Such as, the control system of the parking mechanism may comprise the control unit and the acceleration sensor. The acceleration sensor transfer speed condition to the control unit, then the judge of starting the parking mechanism or not is made. The judge may be made by people according to the condition provided by the acceleration sensor, or, be made by the chip with the predetermined program. For the conditions that need to start the parking mechanism, those skilled in the art and the experienced drivers can make the specific decision according to the specific conditions like the road condition, weather, and the vehicle type.

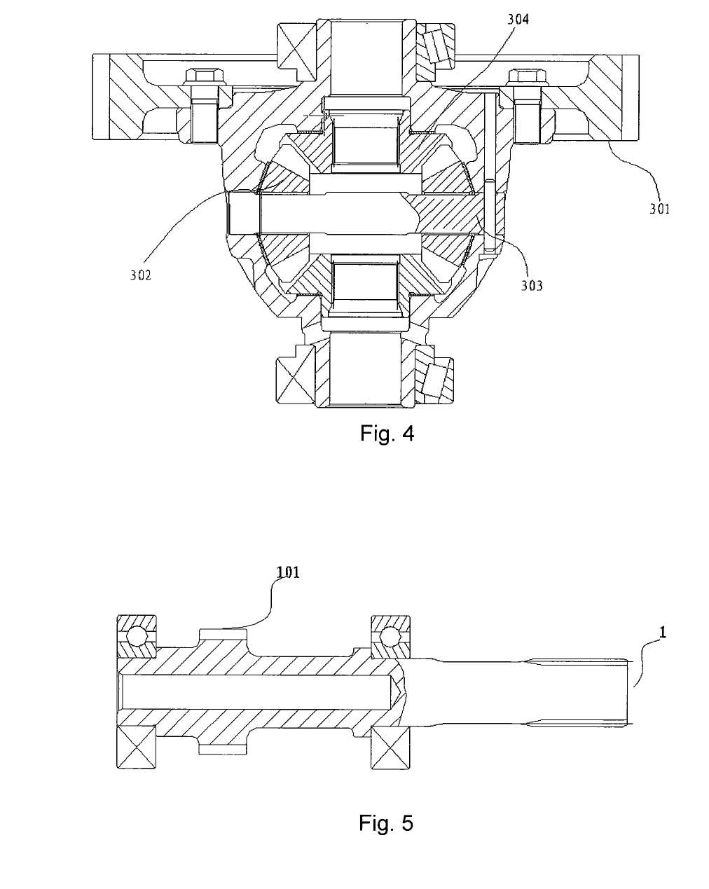

According to FIG. 4, in one embodiment, the differential 3 comprises a driven gear 301, a planetary gear 302, a planetary gear shaft 303 and a half axle gear 304. The driven gear 301 of the differential is engaged to the drive gear 104 of the countershaft, so the countershaft 2 rotates to drive the planetary gear 302 to rotate, and the planetary gear 302 rotates to drive the half axle gear 304 to rotate.

For the four-wheel vehicle, the planetary gear 302 drives the half axle gears of both the left differential and the right differentials, the half axle gears of the left differential and the right differential drive the left wheel and the right wheel separately. When the vehicle goes straight, the speeds of the left wheel, the right wheel and the planetary gear are equal and keep the balance. While the vehicle turning, it leads to the decrease of the rotation speed of the inside vehicle wheel and the increase of the rotation speed of the outside vehicle wheel, then the balance is broke. The broken balance affects the half axle gear through the half axle to force the planetary gear 302 to autorotation; the autorotation of the planetary gear 302 drives the half axle gear of the outside vehicle wheel to rotate fast, and drives the half axle gear of the inside vehicle wheel to rotate slowly, then realize the difference of the rotation speed of the two wheel. For describing simply, the FIG. 2 and the FIG. 4 only show the half axle gear of the driving wheel.

In one embodiment, the differential 3 drives the front wheel of the vehicle. While turning, the driving direction is easy to control and over-steering is prevented, thus improving driving safety.

In one embodiment, the drive gear 101 of the main shaft, the driven gear 102 of the countershaft, the differential gear 103 and the drive gear 104 of the countershaft are helical gears, so the transmission mechanism is stable and less noise.

In one embodiment, the maximum input power is about 160 kw, the maximum input torque is about 450N-M, and the rotation speed is about 700 rpm at the maximum input power.

In one embodiment, a vehicle comprises the above vehicle drive device. In another embodiment, the vehicle drive device includes a main shaft 1 operatively coupled to a motor of the vehicle, where the main shaft 1 has a drive gear 101, and a countershaft 2 has a drive gear 104 and a driven gear 102. The drive gear 101 of the main shaft is configured to engage the driven gear 102 of the countershaft. Also included is a differential 3 having a driven gear 301 and a half axle gear 304, where the drive gear 104 of the countershaft 2 is configured to engage the driven gear 301 of the differential 3, and the half axle gear 304 of the differential 3 is configured to drive a wheel of the vehicle. A parking mechanism is connected with the countershaft 2 and is configured to lock the countershaft 2 in a parking mode

The main shaft 1 is connected to the vehicle drive motor to be the power input shaft. The drive gear 101 is engaged with the driven gear 102 of the countershaft 2. When the drive motor drives the main shaft 1 rotating, the main shaft drives the countershaft 2 to rotate by the engagement of the drive gear 101 with the driven gear 102. Because the driven gear 301 of the differential is engaged with the drive gear 104 of the countershaft, the countershaft 2 rotates to drive the differential 3 to operate. The half axle shaft 304 of the differential is connected to the vehicle wheel, so the differential 3 drives the vehicle wheel to rotate by the rotation of the half axle shaft 304 of the differential.

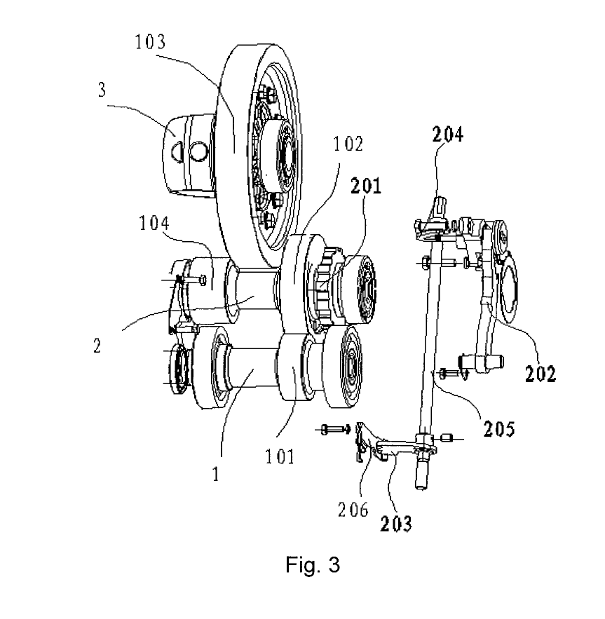

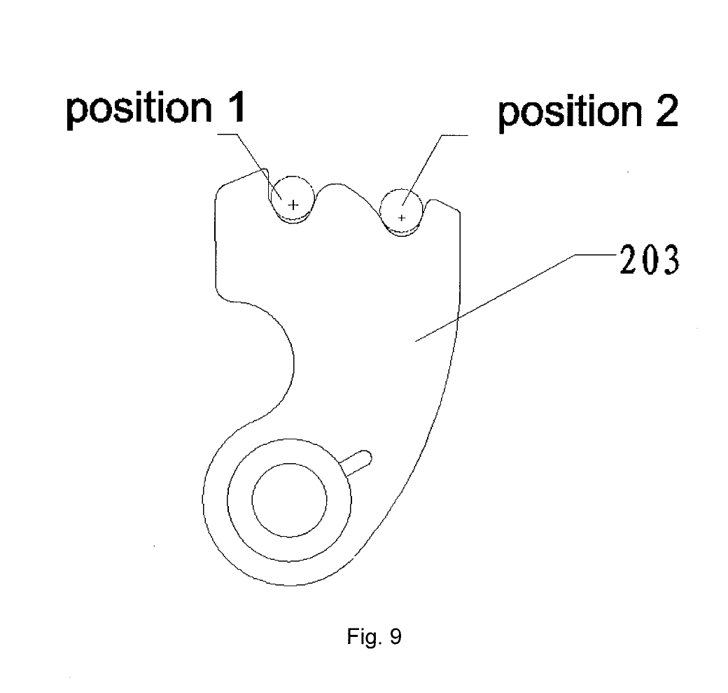

According to FIG. 2, FIG. 3, FIG. 7 and FIG. 8, in one embodiment, a parking mechanism further comprises a ratchet wheel 201 located on the countershaft 2, a ratchet hand 202 installed on a body portion of the vehicle, a parking transmission shaft 205 having a first end and a second end, a parking motor 4 connected to the first end of the parking transmission shaft 205 and configured to selectively rotate the parking transmission shaft 205, a positioning block board 203 coupled to the second end of the parking transmission shaft 205 and configured to retain the parking transmission shaft 205 in a fixed orientation and permit the parking transmission shaft 205 to rotate, a push rod 204 configured to reciprocally engage the ratchet hand 202, and a positioning board spring 206 coupled to the positioning block board 203.

The other end of the positioning block board 203 is connected to one end of the positioning board spring 206, while the other end of the positioning board spring 206 is fixed on the transmission body. According to FIG. 9, the positioning block board 203 is in position 1. When parking, the positioning block board 203 rotates with the rotation of the motor to position 2 to realize parking The rotation of the parking transmission shaft 205 drives the push rod 204 to reciprocally engage and disengage the ratchet hand with the ratchet wheel 201.

When parking, the parking motor 4 drives the parking transmission shaft 205 to rotate. Because the push rod 204 is connected with the parking transmission shaft 205, the rotation of the parking transmission shaft 205 may drive the push rod 204 to rotate, furthermore, the push rod 204 drives the ratchet hand 202 to engage to the ratchet wheel 201. Because the ratchet wheel 201 is connected to the countershaft 2, the engagement of the ratchet hand 202 and the ratchet wheel 201 may stop the rotation of the countershaft 2, namely, the countershaft is locked. The driven gear 102 of the countershaft is always engaged to the driven gear 301 of the differential, so the lock of the countershaft 2 stops the rotation of the differential 3, and then the wheel is locked, which is the goal of the parking mechanism.

Whereas, while the parking not required, the parking motor 4 drives the parking transmission shaft 205 to rotate. Because the push rod 204 is connected with the parking transmission shaft 205, the rotation of the parking transmission shaft 205 may drive the push rod 204 to rotate, furthermore, the push rod 204 drives the ratchet hand 202 to disengage to the ratchet wheel 201. Because the ratchet wheel 201 is connected to the countershaft 2, the disengagement of the ratchet hand 202 and the ratchet wheel 201 may drive the countershaft 2 to rotate. The driven gear 102 of the countershaft is always engaged to the driven gear 301 of the differential, so the rotation of the countershaft 2 drives the differential to operate, and then the wheel is droved to rotate.

In addition, the vehicle drive device may drive the front wheel, also the back wheel. Those skilled in the art can choose it according to the specific condition. In one embodiment, the front wheel is driven, the driving direction is easy to control, and over-steering is reduced or eliminated, thus improving turning control. The driving wheel receives the weight of the engine and the driving axle, which can increase the adhesive force of the driving wheel, so as to improve vehicle performance in wet-skid road conditions. Another advantage for the front wheel driving is that the interior space is increased. Further, without the back differential, the trunk space is increased.

In the embodiments of present invention, the vehicle with the vehicle drive device of the present invention may be any type vehicle that can use the electrical power as at least part of the resource and includes but is not limited to the electric vehicle and the hybrid vehicle.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A vehicle drive device, comprising:
a main shaft operatively coupled to a motor of the vehicle, the main shaft having a drive gear;
a countershaft having a drive gear and a driven gear, the drive gear of the main shaft configured to engage the driven gear of the countershaft;
a differential having a driven gear and a half axle gear, the drive gear of the countershaft configured to engage the driven gear of the differential, and the half axle gear of the differential configured to drive a wheel of the vehicle; and
a parking mechanism connected with the countershaft and configured to lock the countershaft in parking mode.

2. The drive device of claim 1, wherein the parking mechanism further comprises:
a ratchet wheel located on the countershaft;
a ratchet hand installed on a body portion of the vehicle;
a parking transmission shaft having a first end and a second end;
a parking motor connected to the first end of the parking transmission shaft and configured to selectively rotate the parking transmission shaft;
a positioning block board coupled to the second end of the parking transmission shaft and configured to retain the parking transmission shaft in a fixed orientation and permit the parking transmission shaft to rotate;
a push rod configured to reciprocally engage the ratchet hand; and
wherein rotation of the parking transmission shaft drives the push rod to reciprocally engage and disengage the ratchet hand with the ratchet wheel.

3. The drive device of claim 2, wherein a stopping tooth of the ratchet hand is configured to selectively engage a corresponding recess in the ratchet wheel, and wherein the stopping tooth and the corresponding recess are rectangular or arc in shape.

4. The drive device of the claim 2, wherein the ratchet hand includes a return spring configured to bias the ratchet hand away from the ratchet wheel.

5. The drive device of the claim 1, wherein the drive gear of the main shaft, the driven gear of the main shaft, the driven gear of the differential, and the drive gear of the countershaft are helical gears.

6. The drive device of the claim 1, wherein the driven gear of the countershaft is connected to the countershaft by a spline connection.

7. The drive device of the claim 1, wherein the main shaft and the drive gear of the main shaft are formed as a single-body? pinion shaft.

8. A vehicle having at least three wheels and including the drive device of claim 1.

9. The vehicle of the claim 8, wherein the drive device drives at least one front wheel of the vehicle.

10. The vehicle of the claim 8, wherein the vehicle is an electric vehicle or a hybrid vehicle.

11. A vehicle drive device, comprising:
a main shaft operatively coupled to a motor of the vehicle, the main shaft having a drive gear;
a countershaft having a drive gear and a driven gear, the drive gear of the main shaft configured to engage the driven gear of the countershaft;
a differential having a driven gear and a half axle gear, the drive gear of the countershaft configured to engage the driven gear of the differential, and the half axle gear of the differential configured to drive a wheel of the vehicle;
a parking mechanism connected with the countershaft and configured to lock the countershaft in a parking mode, the parking mechanism further comprising:
a ratchet wheel located on the countershaft;
a ratchet hand installed on a body portion of the vehicle;
a parking transmission shaft having a first end;
a parking motor connected to the first end of the parking transmission shaft and configured to selectively rotate the parking transmission shaft;
a push rod configured to reciprocally engage the ratchet hand; and
wherein rotation of the parking transmission shaft drives the push rod to reciprocally engage and disengage the ratchet hand with the ratchet wheel.

12. The drive device of claim 11, wherein a stopping tooth of the ratchet hand is configured to selectively engage a corresponding recess in the ratchet wheel, and wherein the stopping tooth and the corresponding recess are rectangular or arc in shape.

13. The drive device of the claim 11, wherein the ratchet hand includes a return spring configured to bias the ratchet hand away from the ratchet wheel.

14. The drive device of the claim 11, wherein the drive gear of the main shaft, the driven gear of the main shaft, the driven gear of the differential, and the drive gear of the countershaft are helical gears.

15. The drive device of the claim 11, wherein the driven gear of the countershaft is connected to the countershaft by a spline connection.

16. The drive device of the claim 11, wherein the main shaft and the drive gear of the main shaft are formed as a single-body? pinion shaft.

17. A vehicle having at least three wheels and including the drive device of claim 11.

18. The vehicle of the claim 17, wherein the drive device drives at least one front wheel of the vehicle.

19. The vehicle of the claim 17, wherein the vehicle is an electric vehicle or a hybrid vehicle.
